(19) United States
(12) Patent Application Publication
(10) Pub. No.: US 2012/0148075 A1
(43) Pub. Date: Jun. 14, 2012

(54) METHOD FOR OPTIMIZING REPRODUCTION OF AUDIO SIGNALS FROM AN APPARATUS FOR AUDIO REPRODUCTION

(75) Inventors: Aik Hee Daniel GOH, Singapore (SG); Ee Hui SIEK, Singapore (SG); Susimin SUPRAPMO, Singapore (SG)

(73) Assignee: Creative Technology Ltd, Singapore (SG)

(21) Appl. No.: 12/963,582

(22) Filed: Dec. 8, 2010

(51) Int. Cl. H04R 5/02

(52) U.S. Cl. 381/303

(57) ABSTRACT

There is provided a method for optimizing reproduction of audio signals from an apparatus for audio reproduction with the apparatus for audio reproduction having a variable number of speakers. The method includes determining performance characteristics of each of the variable number of speakers; comparing performance characteristics of each of the variable number of speakers with each other; and designating a master speaker from the variable number of speakers either with or without manual intervention.

### FIELD OF INVENTION

This invention relates to a method for reproduction of audio signals, primarily in relation to optimizing the reproduction of audio signals from an apparatus with a variable number of speakers.

### BACKGROUND

Multi-speaker audio systems currently in the market may be wired, wireless, or a hybrid with a combination of the aforementioned. Wired audio systems rely on cables to transmit signals between source and amplifier, and between that and the speakers. However, the use of the cables creates issues pertaining to clutter due to the cables and undesirable aesthetics which has driven up demand for wireless speaker systems by consumers who wish to avoid the aforementioned issues.

There are currently several forms of wireless speaker systems which have been introduced onto the market. However, each of these various forms of wireless speaker systems have limitations which are detrimental to the usability of such wireless speaker systems.

The first form of wireless speaker systems is a direct playback type whereby a single speaker is connected wirelessly to an audio source. In a direct playback type of wireless speaker system, it is necessary for the audio source to either have or be coupled with a compatible wireless transceiver to enable communication with the speaker. A typical example of compatible wireless transceivers involves use of radio frequency waves like Bluetooth.

The second form of wireless speaker systems is a multi-room playback type whereby a transmitter unit relays identical audio signals emanating from an audio source to one or more speakers in more than one room to receive the audio signals wirelessly such that audio content heard in the various rooms are identical. A typical example of the wireless transmitter unit for the second form of wireless speaker systems involves use of 2.4 GHz radio frequency waves which have a reasonable range of deployment.

The third form of wireless speaker systems is a multi-channel playback type whereby a wireless transmitter transmits different streams of audio to multiple speakers in a single room. This is typically known as surround sound speaker systems and is best utilized when consuming movie content with multi-channel audio tracks. A typical example of the wireless transmitter unit for the third form of wireless speaker systems involves use of 2.4 GHz radio frequency waves which have a reasonable range of deployment.

In the aforementioned forms of wireless speaker systems, it is usual for the wireless speaker systems to use hardware such as, for example, transmitter, wireless rear speaker, wireless subwoofer, and the like which are bespoke for a particular wireless speaker system, and as such, the individual constituents of the wireless speaker systems do not have much functionality when deployed individually.

This is especially problematic for the multi-channel playback type of wireless speaker systems, as rear speakers are often either incorrectly installed location-wise or are discarded because of their adverse impact on interior decor aesthetics. In such instances, both the rear speakers and the transmitter which are bespoke to the wireless speaker system, become redundant. Even though consumers are aware of tangible benefits that multi-channel speaker setups bring towards movie and music playback, the prevalence of such instances has unfortunately led to widespread user and market aversion towards multi-channel speaker setups.

Finally, the popularity of multi-room playback type of wireless speaker systems has been battered in view of the ubiquity of low cost, large storage capacity, and network capable media playback devices and the fact that an appearance of individual speakers of the multi-room playback type of wireless speaker systems are not likely to be able to match interior decor aesthetics in various rooms.

The present invention aims to address the aforementioned issues in relation to wireless speaker systems.

### SUMMARY

There is provided a method for optimizing reproduction of audio signals from an apparatus for audio reproduction with the apparatus for audio reproduction having a variable number of speakers. The method includes determining performance characteristics of each of the variable number of speakers; comparing performance characteristics of each of the variable number of speakers with each other; and designating a master speaker from the variable number of speakers either with or without manual intervention. The manual intervention may involve activating a specific mode on the designated master speaker.

The method may further include identifying a location of each of the variable number of speakers; determining a distance between each of the variable number of speakers if each of the variable number of speakers is within a single room; determining physical features around the location of each of the variable number of speakers; determining cumulative output levels of the variable number of speakers and setting the performance characteristics of a subwoofer added to the variable number of speakers; and calibrating the apparatus for audio reproduction by using a microphone coupled with the designated master speaker to enable audio pulses to be received from each of the variable number of speakers excluding the designated master speaker.

It is advantageous that each of the variable number of speakers includes a bi-directional transceiver.

The performance characteristics of each of the variable number of speakers refers to at least one parameter such as, for example, frequency response, maximum sound pressure level, gain, compression settings and so forth.

It is preferable that a speaker from the variable number of speakers is designated as the master speaker based on arbitrary parameters of either speaker location or upstream processing capability. Preferably, the location of each of the variable number of speakers is defined with reference to a position of the designated master speaker. It is preferable that the designated master speaker controls and coordinates the variable number of speakers in the apparatus for audio reproduction. A microphone may be built into a device connectible to the designated master speaker.

The determination of whether each of the variable number of speakers is within a single room may include at least one manner such as, for example, use of optics beams, use of audio signals and so forth. The determination of physical features of the location of each of the variable number of speakers may also include at least one manner such as, for example, direct input of information, use of optics beams, use of audio signals and so forth.

It is preferable that each of the variable number of speakers function independently when either the distance between each of the variable number of speakers is beyond a range suitable for the performance characteristics of at least one of the variable number of speakers, or the variable number of speakers are separated by room boundaries. Advantageously, each of the variable number of speakers may be capable of relaying audio signals amongst each other when each of the variable number of speakers function independently.

### DESCRIPTION OF FIGURES

In order that the present invention may be fully understood and readily put into practical effect, there shall now be described by way of non-limitative example only preferred embodiments of the present invention, the description being with reference to the accompanying illustrative drawings:

FIG. 1 shows a process flow for a method of the present invention.

FIG. 2 shows a schematic diagram for data flow between a master speaker and a slave speaker used in the method of FIG. 1.

FIG. 3 shows a schematic diagram for any speaker used in the method of FIG. 1.

### DESCRIPTION OF PREFERRED EMBODIMENTS

The present invention relates to a method which will be described in a process flow. It should be noted that an order of the process flow of the method need not be strictly adhered to in order to fall within a scope of the present invention.

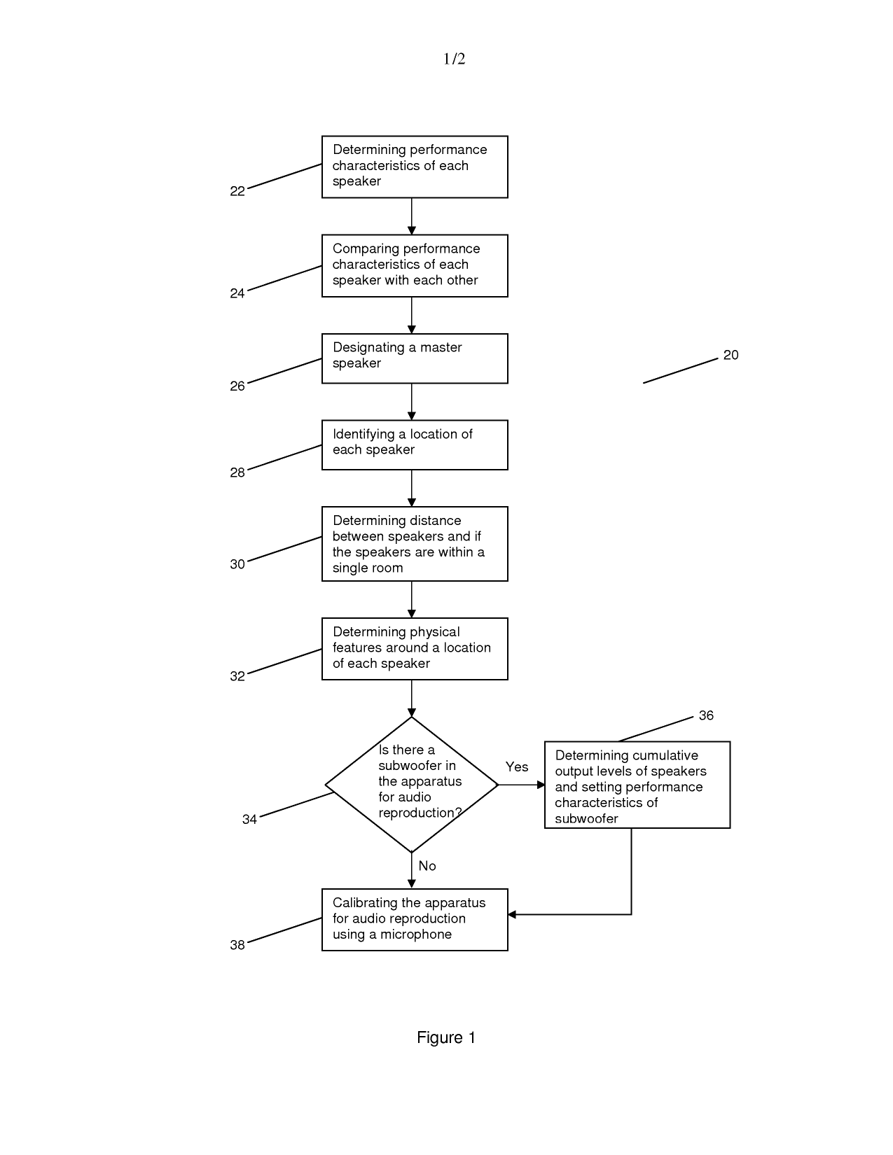

Referring to FIG. 1, there is provided a method 20 for optimizing reproduction of audio signals from an apparatus for audio reproduction. The apparatus for audio reproduction may be a speaker system having a variable number of speakers. Each of the variable number of speakers need not be identical. Referring to FIG. 3, there is shown a generalized schematic view of a speaker 80 which is able to be employed in the apparatus for audio reproduction. Each speaker 80 is a fully autonomous unit either incorporated with or coupled to a bi-directional transceiver 82, with at least one acoustic transducer 84. Each speaker 80 may be capable of operating independently or in a plurality, within a single room or distributed across multiple rooms, while wirelessly connected to an audio source without a need for an intervening transmitter unit.

The method 20 includes determining performance characteristics of each of the variable number of speakers (22). The performance characteristics of each of the variable number of speakers refers to at least one parameter such as, for example, frequency response, maximum sound pressure level, gain, compression settings and the like. The at least one parameter may relate to either a physical or acoustic attribute of each speaker.

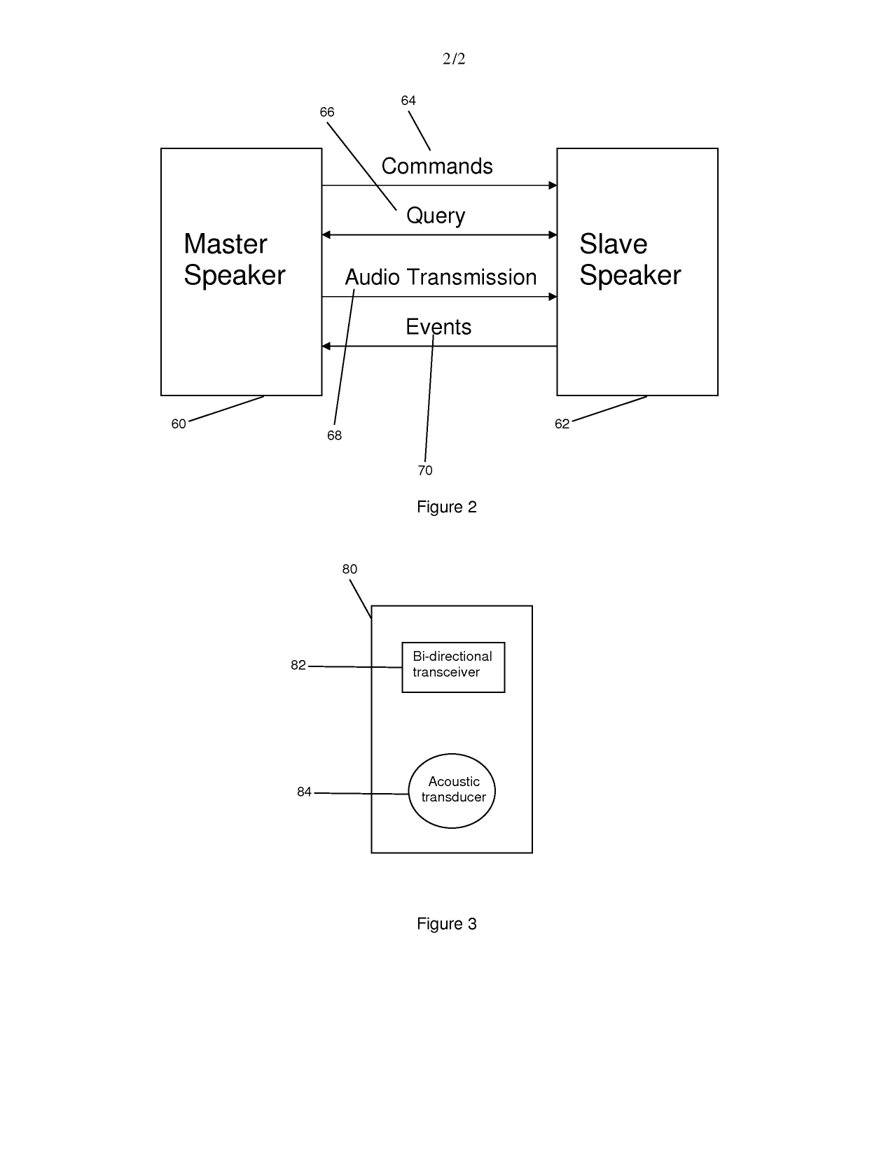

The performance characteristics of each of the variable number of speakers are subsequently compared with each other (24) and a master speaker is designated from the variable number of speakers either with or without manual intervention (26). It should be noted that manual intervention may involve activating a specific mode on the designated master speaker. A speaker from the variable number of speakers may be designated as the master speaker based on arbitrary parameters such as, for example, speaker location, upstream processing capability, and the like. The master speaker may reduce its own gain and alter the frequency response so as to produce a substantially equivalent sonic output to a slave speaker. The designated master speaker controls and coordinates the variable number of speakers in the apparatus for audio reproduction in a manner as shown in FIG. 2.

Referring to FIG. 2, a speaker with superior performance characteristics is designated as a master speaker 60, while the other speaker(s) is a slave speaker 62. It should be noted that these master 60 and slave 62 designations are not necessarily analogous to typical transmitter-receiver pairings. The master speaker 60 controls and coordinates the system, but is also capable of serving as a receiving or transmitting unit for audio signals after the setup for the apparatus for audio reproduction is complete. A wireless connection between the master 60 and the slave 62 speakers will be described thereafter as the “speaker link” and is not represented in FIG. 2 as the “speaker link” is inherently present in order for data to be transferred between the master 60 and the slave 62 speakers.

The data transferred between the master 60 and the slave 62 speakers is divided into four types, namely, commands 64, query 66, audio transmission 68, and events 70. The data may generally be deemed to include attributes (permanent parameters of each speaker), status information (operational parameters of each speaker), and register information (toggling instructions for attributes). The four types of data may be described as follows:
commands 64: master speaker 60 transmits instruction to slave speaker 62, either individually or universally, to effect a change in the settings of the slave speaker 62.
query 66: master speaker 60 polls a slave speaker 62 individually, and receives the performance characteristics and location of each slave speaker 62.
audio transmission 68: master speaker 60 broadcasts audio signals to slave speaker 62.
events 70: slave speaker 62 transmits interrupts to master speaker 60 to indicate, for instance, user input (for example, toggling controls of a slave speaker 62), change in status, and the like.

The method 20 further includes identifying a location of each of the variable number of speakers (28). The location of each of the variable number of speakers is defined with reference to a position of the designated master speaker. The location of each of the variable number of speakers may be perceived in a manner where a room is a sealed rectangular box. Doors, corridors, passages and other architectural features may cause the room to deviate from the form of a rectangular box. In order to address such an issue, a series of overlapping boxes could be grouped together to better represent the room and correspondingly, also better represent the location of each of the variable number of speakers.

The method 20 also includes determining a distance between each of the variable number of speakers and if each of the variable number of speakers is within a single room (30). This could be carried out by:
Optics components operating in, for example, UV, visible, IR spectrums and so forth, whereby the optics components in each speaker are used to determine both distance between speakers and whether the speakers are in a single room. However, it should be noted that sole use of optics components would be undesirable given the requirement for line of sight operation.
Audio detection within either audible or ultra-sonic ranges, whereby audio signals are used to determine both distance between speakers and whether the speakers are in a single room. However, it should be noted that audio detection does not have a requirement for line of sight operation.

When the speakers are determined to be either separated by room boundaries such as a wall/partition, or are too distant (beyond a range suitable for the performance characteristics of at least one of the variable number of speakers) to function effectively as a single system in view of the individual performance characteristics of each of the variable number of speakers, the speakers may function independently. It should be noted that each of the variable number of speakers is capable of relaying audio signals amongst each other when each of the variable number of speakers function independently.

For instance, when the speakers are located in different rooms, each speaker may be configured such that it reproduces all channels of an incoming audio signal when functioning independently. When a speaker is capable of reproducing stereo sound only, the speaker may be configured in a manner such that an incoming multichannel audio signal may be either mixed down to stereo, or virtualized such that this signal could be audibly reproduced over just two channels. But when the speakers are repositioned such that they are now located within a single room, the speakers may correspondingly be re-configured such that each speaker only reproduces a portion of the incoming audio signal. To further illustrate the aforementioned, when there is an incoming stereo audio signal and three speakers in a single room, one of the speakers may be used to playback the left channel signal, another the right channel signal while a third speaker may be used to reproduce a synthesized low frequency channel derived from the left and right audio signals.

In a one room system, the distance between speakers may be used as an input parameter for audio signal processing to ensure that an optimal listening experience is maintained regardless of how the system is physically arranged. For example, when listening to a stereo setup, an optimal listening experience is possible when the speakers are set apart at a distance, such that the two speakers and the listener are located at the vertices of an area defined by an equilateral triangle. Unfortunately, space and aesthetic constraints typically result in speakers being positioned closer than desired. However, such issues may be addressed with the use of audio signal processing whereby much of the lost stereo separation may be restituted with a suitable amount of cross-talk cancellation and midrange (1-4 kHz) equalization—the amount of which is varied according to the distance the speakers are set apart at.

There is also determination of physical features around the location of each of the variable number of speakers (32) in the method 20. The apparatus for audio reproduction could be input with information on the physical layout of the environment it is located in. The information such as, for example, room size, layout, floor plan and so forth may be input into the apparatus via either a conversion software running on an external computing device, or each speaker may incorporate detection capability via at least one manner selected from use of optics beams and use of audio signals (as described in preceding paragraphs) such that physical features of the environment such as, for example, room size, entry and exit points, location of speakers relative to each other, room boundaries and the like may be determined. Determining the physical features around the location of each of the variable number of speakers also allows the apparatus for audio reproduction to make adjustments for audio output due to speaker re-positioning, without a need for manual intervention.

In an instance when the apparatus for audio reproduction includes a subwoofer (34), the method 20 may further include determining cumulative output levels of the variable number of speakers and setting the performance characteristics of the subwoofer added to the variable number of speakers (36). Subwoofers typically improve the performance of the apparatus for audio reproduction by augmenting low frequency sounds that are missing from smaller full range (FR) speakers. By relieving the FR speakers from a burden of producing low frequency sounds, additional improvement in system sound pressure level (SPL) could be obtained as well. When the subwoofer is added, a level, crossover frequency and phase setting of the subwoofer has to be adjusted to match those of the other speakers in the apparatus for audio reproduction. In the method 20, given that the performance characteristics of all speakers are made known to the master speaker as described earlier, the settings of the subwoofer and FR speakers may correspondingly be derived and optimized algorithmically without user intervention or direct measurement.

In a most basic implementation, the master speaker would determine the cumulative output level of the FR speakers, and set the cumulative output level of the subwoofer accordingly. For practical reasons to enable use of lower cost subwoofers and FR speakers in the method 20, the crossover frequency and slope of both subwoofer and FR speakers may be standardized using such as, for example, 80 Hz, Linkwitz-Riley 4^{th} order. The method 20 would be desirable for use in the apparatus for audio reproduction where a lower crossover frequency, and a lower maximum system SPL is tolerated.

Finally, the method 20 may also include calibrating the apparatus for audio reproduction by using a microphone coupled with the designated master speaker to enable audio pulses to be received from each of the variable number of speakers excluding the designated master speaker (38). This allows the apparatus for audio reproduction to detect a position of the listener, and consequently allows for the performance of the speaker system to be optimized for the location of the listener.

The FR speakers and subwoofer should have programmable response characteristics. The master speaker compares the low frequency SPL capability of the FR speakers, to the corresponding low frequency SPL of the subwoofer(s), and derives an optimized crossover frequency and appropriate level settings. Additional parameters of for example, time difference of arrival (TDOA), frequency response and the like may be obtained at the listener's position via a calibration microphone.

When a single speaker is matched to a subwoofer, the maximum SPL of the system is most likely to be limited by the low frequency output capability of the FR speaker. By choosing a higher crossover point for this scenario, a very significant improvement in overall system SPL could be achieved.

A representative small full range speaker might contain 2×2.75″ drivers in a sealed enclosure, powered by 40 w of amplification, and cover a range of 80-20,000 Hz (−3 dB). This gives a maximum midrange SPL of 100 dB/1M, but only 80 dB SPL at 80 Hz/1M before the speaker driver units run out of linear driver excursion. If such a speaker is augmented by a subwoofer, crossed at 80 Hz, it would be clear that the system is still limited by the full range speaker's low frequency SPL to 80+6 dB (contribution from the subwoofer)=86 dB, regardless of the SPL capability of the subwoofer.

To achieve an improvement in the SPL limit, the crossover could be set higher at 180 Hz, where the full range speaker is limited by its linear driver excursion limits to 94 dB. The combination of the subwoofer and full range speaker now yields 94+6 dB=100 dB. The system can now play into low frequency at SPLs comparable to what it could achieve in the midrange. The master speaker, optimizing for SPL, follows the same logic of matching SPLs to set a crossover frequency of 180 Hz. At this higher crossover frequency, however, the TDOA to the listening position between full-range speakers and the subwoofer becomes critical acoustically, and has to be taken into account if flat response is to be achieved. At the 180 Hz crossover frequency as mentioned earlier, the corresponding wavelength is 1.9 m. If the time of flight difference is an odd multiple (for example, 0.95 m, 2.85 m . . . ) of half the wavelength, the output of the FR speaker and subwoofer becomes cancelled at the listener's position.

In most instances, this cancellation would not be complete, but it is evident that time alignment is quite important for systems that uses higher crossover frequency. In order to measure the TDOA of the various speakers, a microphone is connected to the master speaker, and a suitable signal such as an impulse is sent sequentially to each speaker for playback. Comparing the signal received gives a direct readout of the TDOA. Apart from having a reasonably wide bandwidth, there is no need for a especially flat midrange and treble response for the microphone, hence the microphone unit built into either a portable digital playback device or cellular phone which could be connectible to the master speaker.

In a subwoofer-FR speaker setup, the TDOA information may be used to correct for the response irregularity arising from undesirable time alignment in a variety of ways. Firstly, the TDOA could be restituted by means of adjusting a variable delay in either subwoofer or FR speaker. This requires delay capability in both units to be fully functional. Secondly, a frequency dependent delay could be implemented in a transmitting speaker (typically the master FR speaker), such the frequency bands covered by FR speakers and subwoofer are affected by different delays. This correspondingly places the burden of time correction on a transmitting speaker capable of this processing capability and the subwoofer may be relieved of the need for a variable delay block. Thirdly, a gradient and polarity of the crossover unit and the amount of overlap may be manipulated in consideration to the measured TDOA, such that the resultant response is flat. As such, with crossover frequency 180 Hz, TDOA=1.25 m, 4^{th} order Linkwitz Riley crossover slopes, could be made to measure flat at listener's position by reversing the polarity of either subwoofer or FR speaker. In addition, increasing the overlap area, reducing or increasing the slope or Q of each speaker's filtering could be used to compensate for the response irregularity as well.

The microphone could be used to verify the result of the corrective measures as well, to ensure an even response is being produced. This may involve measurement of the apparatus for audio reproduction in the low frequency region below, at and above the crossover point. A swept tone signal may be employed, spatially averaged by separately measuring at the listening position and at several locations at the listener's area, or could involve the listener physically moving the microphone around the listener's area when a single measurement is being made.

It should be noted that when the method 20 is employed for an apparatus for audio reproduction, the user does not need to commit to a pre-configured multi-room system or a pre-configured multi-channel system at a point of purchase as additional speakers may be added when necessary, or used in a different manner as requirements change. For example, the user could start with a single speaker, connected to a source device as a basic sound system. When higher loudness levels and/or a better surround sound movie experience is desired, another speaker(s) could be added. Should the user desire a different audio experience, the additional speaker may be used as an independent speaker in another room. It should be noted that nothing is rendered redundant with a change of configuration.

Whilst there has been described in the foregoing description preferred embodiments of the present invention, it will be understood by those skilled in the technology concerned that many variations or modifications in details of design or construction may be made without departing from the present invention.

1. A method for optimizing reproduction of audio signals from an apparatus for audio reproduction with the apparatus for audio reproduction having a variable number of speakers, the method including:
determining performance characteristics of each of the variable number of speakers;
comparing performance characteristics of each of the variable number of speakers with each other; and
designating a master speaker from the variable number of speakers either with or without manual intervention;
wherein each of the variable number of speakers includes a bi-directional transceiver.

2. The method of claim 1, further including:
identifying a location of each of the variable number of speakers;
determining a distance between each of the variable number of speakers if each of the variable number of speakers is within a single room; and
determining physical features around the location of each of the variable number of speakers.

3. The method of claim 1, further including determining cumulative output levels of the variable number of speakers and setting the performance characteristics of a subwoofer added to the variable number of speakers.

4. The method of claim 2, further including calibrating the apparatus for audio reproduction by using a microphone coupled with the designated master speaker to enable audio pulses to be received from each of the variable number of speakers excluding the designated master speaker.

5. The method of claim 1, wherein the performance characteristics of each of the variable number of speakers refers to at least one parameter selected from a group comprising: frequency response, maximum sound pressure level, gain, and compression settings.

6. The method of claim 1, wherein a speaker from the variable number of speakers is designated as the master speaker based on arbitrary parameters of either speaker location or upstream processing capability.

7. The method of claim 2, wherein the location of each of the variable number of speakers is defined with reference to a position of the designated master speaker.

8. The method of claim 2, wherein the determination of whether each of the variable number of speakers is within a single room includes at least one manner selected from use of optics beams and use of audio signals.

9. The method of claim 2, wherein determination of physical features of the location of each of the variable number of speakers includes at least one manner selected from: direct input of information, use of optics beams and use of audio signals.

10. The method of claim 1, wherein the designated master speaker controls and coordinates the variable number of speakers in the apparatus for audio reproduction.

11. The method of claim 2, wherein each of the variable number of speakers function independently when either the distance between each of the variable number of speakers is beyond a range suitable for the performance characteristics of at least one of the variable number of speakers or the variable number of speakers are separated by room boundaries.

12. The method of claim 11, wherein each of the variable number of speakers is capable of relaying audio signals amongst each other when each of the variable number of speakers function independently.

13. The method of claim 4, wherein the microphone is built into a device connectible to the designated master speaker.

14. The method of claim 1, wherein the manual intervention involves activating a specific mode on the designated master speaker.
